(19) United States
(12) Patent Application Publication
(10) Pub. No.: US 2016/0155356 A1
(43) Pub. Date: Jun. 2, 2016

(54) Interactive Nutrition Game and Methods of Use

(71) Applicant: MAKE EATING FUN, INC., Atwood, CA (US)

(72) Inventors: Gary Jack Heyer, Yorba Linda, CA (US); Amy Currie Heyer, Yorba Linda, CA (US)

(73) Assignee: MAKE EATING FUN, INC., Atwood, CA (US)

(21) Appl. No.: 14/557,300

(22) Filed: Dec. 1, 2014

(51) Int. Cl. G09B 19/00

(52) U.S. Cl. CPC G09B 19/0092

(57) ABSTRACT

An interactive nutrition game and associated methods of use are disclosed for encouraging an at least one child to eat healthy foods. In at least one embodiment, the game includes an at least one healthy food item and an at least one incentive food item for the child to eat. A printed story involving healthy foods provides each of an at least one healthy food placeholder and incentive food placeholder configured for being selectively populated with a name of the at least one healthy food item and at least one incentive food item, respectively. A placemat contains artwork related to the content of the printed story, including each of an at least one designated healthy food location and incentive food location positioned on the placemat and configured for receiving one of the at least one healthy food item and incentive food item, respectively.

### RELATED APPLICATIONS

Not applicable.

### BACKGROUND

The subject of this patent application relates generally to nutrition, and more particularly to an interactive nutrition game configured for encouraging children to eat healthy foods.

Applicant(s) hereby incorporate herein by reference any and all patents and published patent applications cited or referred to in this application.

By way of background, children are often turned off to trying new foods—especially healthy foods like fruits and vegetables—typically due to their unfamiliar smells, textures and colors. In some instances, children can be so resistant to trying such healthy foods that their parents or guardians simply give up. As a result, children tend to eat more junk food—or at least relatively less healthy food—which, in turn, contributes to higher rates of childhood obesity and related health issues. Given that this issue is so widespread, there have been many proposed solutions over the years. Some solutions are simply based on the parent or guardian setting a good example by eating the same healthy foods and encouraging their children to do the same. Should the children remain resistant to eating healthy foods, many such solutions suggest that parents or guardians, in turn, resist the urge to allow their children to eat alternative, more appealing foods, and instead insist that their children eat the healthy foods that are given to them—i.e., if they're hungry, they will have to eat the healthy food. While such solutions achieve the goal of getting children to eat healthy food, these children will be less likely to grow to enjoy such foods as they get older—instead, resorting back to eating less healthy foods when they have the opportunity.

Other solutions suggest that parents or guardians allow their children to use various, sometimes unhealthy, dips when eating healthy foods so as to provide a more appealing or familiar flavor. Still other solutions provide recipes that incorporate certain ingredients that are designed to help mask or improve the smell, texture and/or color of healthy foods. Still other solutions simply suggest that parents or guardians effectively hide healthy foods inside or within other, oftentimes relatively less healthy, foods that their children actually enjoy. Again, while such solutions achieve the goal of getting children to eat healthy food, these techniques—by themselves—can have a tendency to cause children to rely upon, and ultimately require, the presence of such additional ingredients in order to eat the healthy foods, thereby not truly growing to enjoy the healthy foods on their own.

Accordingly, there continues to be a need for a solution that not only achieves the goal of getting children to eat healthy foods, but does so in such a way as to cause them to actually enjoy such foods, so as to ultimately instill in them the importance of such a nutritional diet. Aspects of the present invention fulfill these needs and provide further related advantages as described in the following summary.

### SUMMARY

Aspects of the present invention teach certain benefits in construction and use which give rise to the exemplary advantages described below.

The present invention solves the problems described above by providing an interactive nutrition game and associated methods of use for encouraging an at least one child to eat healthy foods. In at least one embodiment, the game includes an at least one healthy food item and an at least one incentive food item for the at least one child to eat. A printed story involving healthy foods provides an at least one healthy food placeholder positioned within the printed story and configured for being selectively populated with a food name of the at least one healthy food item, and an at least one incentive food placeholder positioned within the printed story and configured for being selectively populated with a food name of the at least one incentive food item. An accompanying placemat contains artwork related to the content of the printed story—namely, an at least one designated healthy food location positioned on the placemat and configured for receiving one of the at least one healthy food item, and an at least one designated incentive food location positioned on the placemat and configured for receiving one of the at least one incentive food item. In use, upon encountering each of the at least one healthy food placeholders while reciting the printed story to the child, the child is encouraged to eat the associated healthy food item positioned on the placemat, and upon eating the at least one healthy food item positioned on the placemat, the child is allowed to eat the at least one incentive food item positioned on the placemat as a reward.

Other features and advantages of aspects of the present invention will become apparent from the following more detailed description, taken in conjunction with the accompanying drawings, which illustrate, by way of example, the principles of aspects of the invention.

### BRIEF DESCRIPTION OF THE DRAWINGS

The accompanying drawings illustrate aspects of the present invention. In such drawings:

FIG. 1 is a perspective view of an exemplary interactive nutrition game, in accordance with at least one embodiment;

FIGS. 2 and 3 are illustrations of select pages of an exemplary game book, in accordance with at least one embodiment; and

FIG. 4 is a flow diagram illustrating an exemplary method of playing the interactive nutrition game, in accordance with at least one embodiment.

The above described drawing figures illustrate aspects of the invention in at least one of its exemplary embodiments, which are further defined in detail in the following description. Features, elements, and aspects of the invention that are referenced by the same numerals in different figures represent the same, equivalent, or similar features, elements, or aspects, in accordance with one or more embodiments.

### DETAILED DESCRIPTION

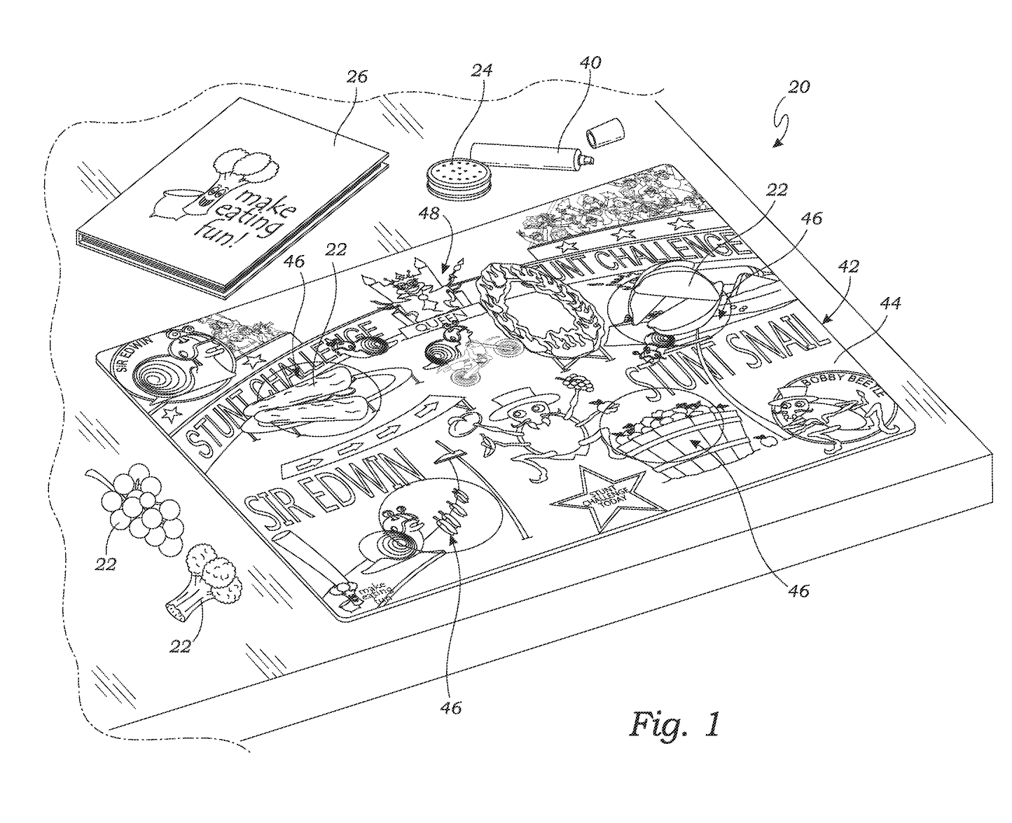

Turning now to FIG. 1, there is shown a perspective view of an exemplary interactive nutrition game 20 for encouraging an at least one child to eat healthy foods, in accordance with at least one embodiment. In at least one embodiment, the game 20 includes an at least one healthy food item 22 and an at least one incentive food item 24 for the at least one child to eat. At the outset, it should be noted that the term “healthy food” is intended to mean any type of food having nutritional benefits and for which it is desired to have the at least one child learn to enjoy eating. The term “incentive food” is intended to mean any type of food—healthy or otherwise—that the at least one child already enjoys eating and, thus, can be used as an incentive or reward for the child to try eating the at least one healthy food item. It should also be noted that while certain types of healthy food items 22 and incentive food items 24 are mentioned herein, they are merely exemplary and used solely for illustrative purposes. Accordingly, the present invention should not be read as being so limited. Instead, in at least one embodiment, any type of healthy food item 22 and/or incentive food item 24, now known or later developed, may be incorporated in the game 20.

With continued reference to FIG. 1, the game 20 also provides a printed story 26 involving healthy foods. As discussed further below, the content of the printed story 26 is designed to engage the child and encourage them to eat (or at least sample) the healthy food items 22—both through the compelling storylines themselves and through the offering of incentive food items 24 as a reward. It should be noted that the term “printed” is intended to include any and all tangible mediums, now known or later developed, through which the story may be delivered, such as physical prints, digital prints, etc. In the embodiment illustrated in FIG. 1, the printed story 26 is a physical print that is bound as a book.

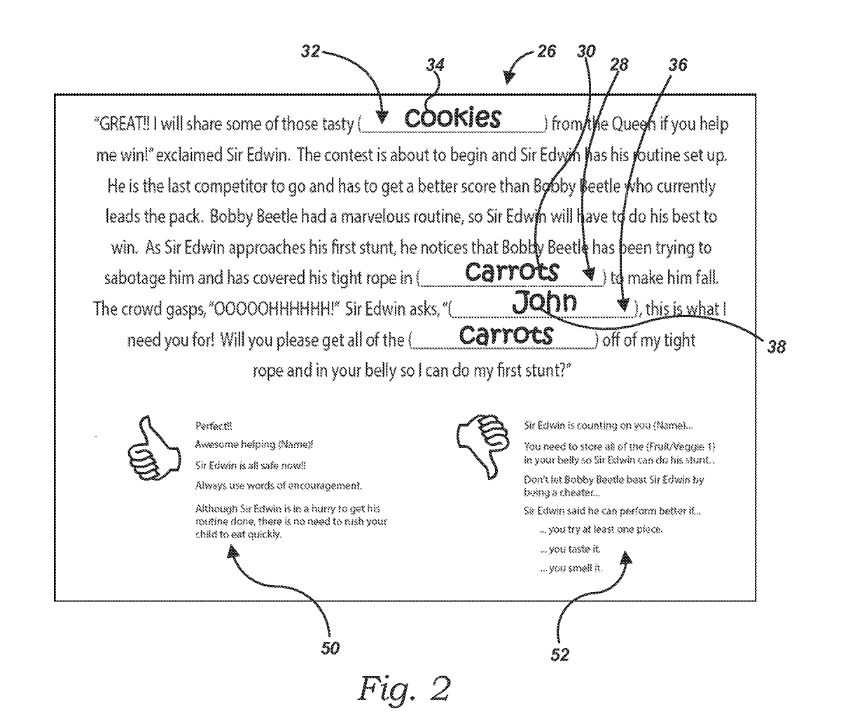

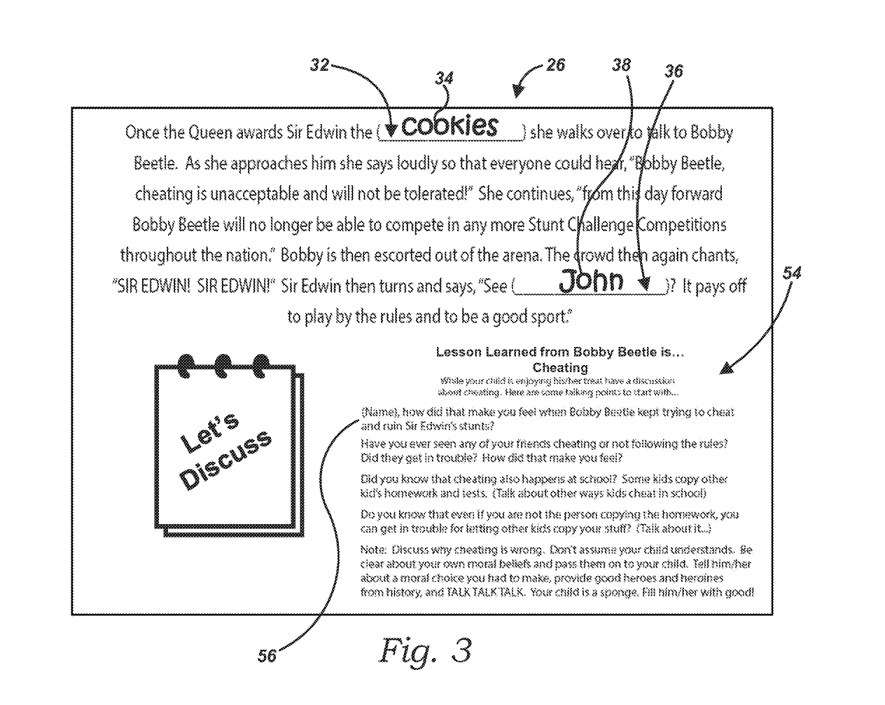

In at least one embodiment, as shown best in the illustrations of FIGS. 2 and 3, the printed story 26 also provides inline placeholders for allowing a parent or guardian of the child to selectively customize and personalize the content of the printed story 26 based on the particular healthy food items 22 and incentive food items 24 being used in the game. In a bit more detail, in at least one such embodiment, the printed story 26 provides an at least one healthy food placeholder 28 positioned within the printed story 26 and configured for being selectively populated with a food name 30 of the at least one healthy food item 22. For example, if one of the healthy food items 22 is a carrot, then the appropriate healthy food placeholders 28 in the printed story 26 would be selectively populated with the food name 30, “carrot.” Each such healthy food item 22 has at least one such corresponding healthy food placeholder 28 within the printed story 26. In at least one embodiment, the printed story 26 provides guidance with respect to each such healthy food placeholder 28. In other words, and as discussed further below, where the printed story 26 provides for the inclusion of more than one healthy food item 22, each healthy food placeholder 28 is appropriately marked so as to designate which of the corresponding food names 30 it should be populated with. Similarly, in at least one embodiment, the printed story 26 also provides an at least one incentive food placeholder 32 positioned within the printed story 26 and configured for being selectively populated with a food name 34 of the at least one incentive food item 24. For example, if one of the incentive food items 24 is a cookie, then the appropriate incentive food placeholders 32 in the printed story 26 would be selectively populated with the food name 34, “cookie.” Each such incentive food item 24 has at least one such corresponding incentive food placeholder 32 within the printed story 26. In at least one embodiment, the printed story 26 provides guidance with respect to each such incentive food placeholder 32. In other words, again, where the printed story 26 provides for the inclusion of more than one incentive food item 24, each incentive food placeholder 32 is appropriately marked so as to designate which of the corresponding food names 34 it should be populated with. In at least one embodiment, the printed story also provides an at least one child placeholder 36 positioned within the printed story 26 and configured for being selectively populated with a child name 38 of the at least one child, thereby allowing the printed story 26 to be further personalized in order to better engage the child. It should be noted that the term “populated” is intended to mean “filled in,” though the actual method of populating or filling in each of the healthy food placeholders 28, incentive food placeholders 32, and child placeholders 36 ultimately depends on the type of tangible medium being utilized by the printed story 26. For example, where the printed story 26 is a digital print, such as an e-book, the placeholders 28, 32 and 36 may be populated by the parent or guardian typing in the appropriate food name 30 and 34 or child name 38. Where the printed story 26 is a physical print, such as the book in the embodiment illustrated in FIG. 1, the placeholders 28, 32 and 36 may be populated by the parent or guardian handwriting in the appropriate food name 30 and 34 or child name 38. In still further embodiments, any other means or methods for populating the placeholders 28, 32 and 36—now known or later developed—may be substituted in the appropriate contexts. In at least one embodiment where the printed story 26 is a physical print, the printed story 26 is laminated and configured for allowing the parent or guardian to populate each of the placeholders 28, 32 and 36 using a dry-erase marker 40, thereby allowing the printed story 26 to be re-used over and over with different healthy food items 22, incentive food items 24, and even children.

Referring again to FIG. 1, the game 20 also provides a placemat 42 containing artwork 44 related to the content of the printed story 26. In a bit more detail, in at least one such embodiment, the placemat 42 provides an at least one designated healthy food location 46 positioned on the placemat artwork 44, in accordance with the content of the printed story 26, and configured for receiving one of the at least one healthy food item 22. Similarly, in at least one embodiment, the placemat 42 also provides an at least one designated incentive food location 48 positioned on the placemat artwork 44, in accordance with the content of the printed story 26, and configured for receiving one of the at least one incentive food item 24. It should be noted that while the at least one healthy food location 46 and incentive food location 48 might incorporate certain express visual elements—such as a circle around each such healthy food location 46 and incentive food location 48 as in the artwork 44 shown in FIG. 1, for example—to indicate the respective locations in some embodiments, in other embodiments, such visual indicators may be omitted, with locational references being made in the content of the associated printed story 26 instead. It should also be noted that while the placemat artwork 44 shown in the embodiment illustrated in FIG. 1 is two-dimensional, the artwork 44 should not be read as being so limited. For example, in further embodiments, the artwork 44 may be three-dimensional, or a combination of two-dimensional and three-dimensional. Still further, the artwork 44 may incorporate any form or combination of forms of visual mediums now known or later developed, such as drawings, paintings, sculptures, photos, holograms, etc.

As mentioned above, in at least one embodiment, the printed story 26 provides for the inclusion of more than one healthy food item 22, such that each healthy food placeholder 28 is appropriately marked so as to designate which of the corresponding food names 30 it should be populated with. For example, the embodiment illustrated in FIG. 1 provides for the inclusion of four different healthy food items 22. As such, the printed story 26 provides a first healthy food placeholder 28 for a first healthy food item 22, a second healthy food placeholder 28 for a second healthy food item 22, a third healthy food placeholder 28 for a third healthy food item 22, and a fourth healthy food placeholder 28 for a fourth healthy food item 22. Relatedly, in such an embodiment, the placemat artwork 44 provides a corresponding first healthy food location 46 for the first healthy food item 22, a second healthy food location 46 for the second healthy food item 22, a third healthy food location 46 for the third healthy food item 22, and a fourth healthy food location 46 for the fourth healthy food item 22. Again, this is merely one example, as the game 20 may allow for the inclusion of any number of healthy food items 22, with the respective number of healthy food placeholders 28 and healthy food locations 46 being adjusted accordingly. The same is true for incentive food items 24 (and corresponding incentive food placeholders 32 and incentive food locations 48) as well, in at least one embodiment.

Referring again to FIG. 2, in at least one embodiment, the printed story 26 further provides an at least one eating suggestion 50 that provides guidance as to how the parent or guardian might properly praise the child upon eating the at least one healthy food item 22, so as to better ensure that the child is properly associating the act of eating the healthy food item 22 with positive results. Similarly, in at least one embodiment, the printed story 26 further provides an at least one refusal suggestion 52 that provides guidance as to how the parent or guardian might properly encourage—rather than discourage—the child upon their refusing to eat the at least one healthy food item 22, so as to better ensure that the child does not develop any negative associations with the healthy food item 22.

Referring again to FIG. 3, in at least one embodiment, the printed story 26 further provides an at least one life lesson section 54 that provides an at least one talking point 56 that the parent or guardian may use to open discussions with the child at the conclusion of the printed story 26 in order to engage in meaningful discussions with the child about important, teachable moments, beyond just nutrition and the healthy food items 22.

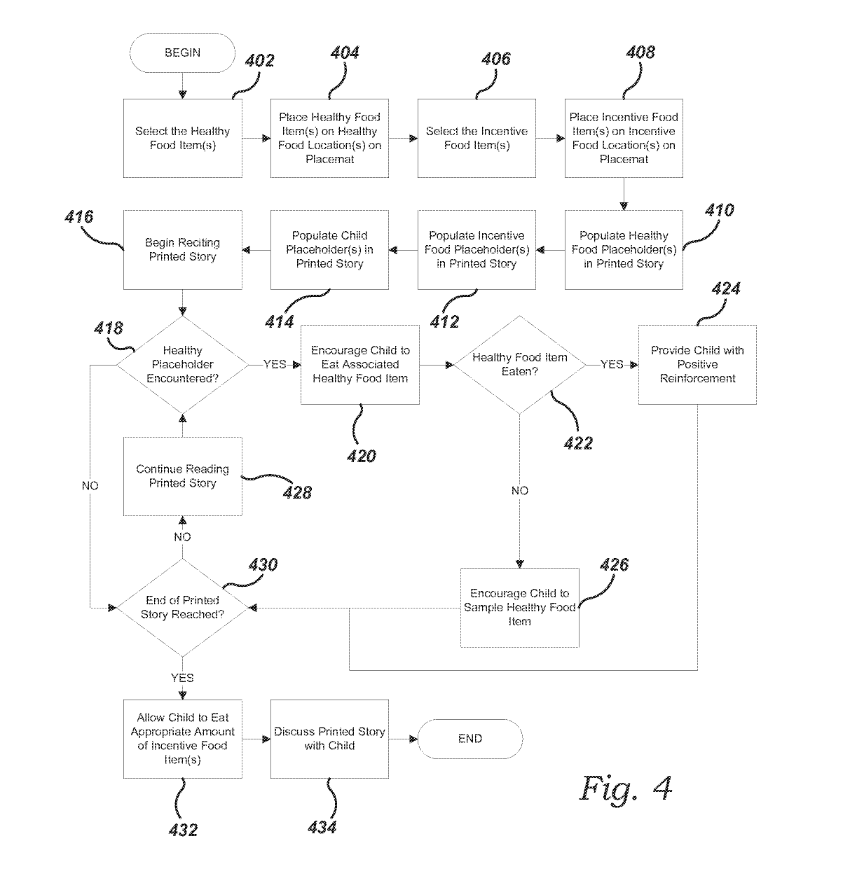

With respect to actually using or “playing” the game, in at least one embodiment, as illustrated in the flow diagram of FIG. 4, the parent or guardian—with the optional help of the child—first selects the at least one healthy food item 22 for the child to eat (402) and places the at least one healthy food item 22 on the corresponding at least one designated healthy food location 46 provided by the placemat artwork (404). The number of healthy food items 22 is dictated by the number allowed by the printed story 26 and associated placemat 42. Furthermore, in at least one embodiment, the parent or guardian may choose to selectively order the placement of the at least one healthy food item 22 based on the child's familiarity with them—i.e., placing relatively more familiar (or more liked) healthy food items 22 before relatively less familiar (or less liked) healthy food items 22 so as to help ease the child into trying the latter healthy food items 22. The at least one incentive food item 24 is also selected (406) and placed on the corresponding at least one designated incentive food location 48 (408). The parent or guardian also selectively populates the at least one healthy food placeholder 28 in the printed story 26 (410), along with the at least one incentive food placeholder 32 (412), with the appropriate food names 30 and 34 of the respective healthy food items 22 and incentive food items 24. In at least one embodiment, the parent or guardian also selectively populates the at least one child placeholder 36 in the printed story 26 (414) with the child name 38 of the at least one child. Once the healthy food items 22 and incentive food items 24 have been appropriately positioned on the placemat 42, and the printed story 26 has been appropriately populated with the relevant information, the parent or guardian begins to recite the printed story 26 to the child (416). Upon encountering each healthy food placeholder while reciting the printed story 26 (418), where the printed story 26 instructs the child to eat the associated healthy food item 22, the parent or guardian encourages the child to eat the associated healthy food item 22 positioned on the corresponding healthy food location 46 of the placemat 42 (420). Upon the child eating the associated healthy food item 22 (422), the parent or guardian provides the child with positive reinforcement (424). Alternatively, should the child refuse to eat the healthy food item 22 (422), the parent or guardian encourages the child to at least sample the healthy food item 22 (426) while trying to avoid discouraging the child. The parent or guardian continues to recite the printed story 26 (428) until the end of the story is reached (430), by which point the child will have had the opportunity to eat each of the healthy food items 22 positioned on the placemat 42. The parent or guardian then allows the child to eat at least a portion of the at least one incentive food item 24 positioned on the placemat 42 as a reward (432), the amount of incentive food items awarded 24 depending on the amount of healthy food items 22 that the child successfully ate. Additionally, in at least one embodiment, the parent or guardian may choose to discuss the content of the printed story 26 with the child while the child eats the incentive food item 24 (434). For example, where the printed story 26 provides the life lesson section 54 and at least one related talking point 56, the parent or guardian may incorporate those into any such discussions. It should be noted that in at least one alternate embodiment, depending on the content of the printed story 26 and associated placemat 42, the above steps may be modified such that the parent or guardian allows the child to eat at least one of the incentive food items 24 after successfully eating an acceptable amount of each healthy food item 22 (rather than waiting to give the incentive food item 24 to the child at the conclusion of the printed story 26). Thus, the above order of steps are merely exemplary and should not be read as being limiting in any way.

Thus, not only does the game 20 offer parents and guardians a tool to get their children to eat healthy food items 22, such as fruits and vegetables, but it also promotes parent/child interaction. Furthermore, in at least one embodiment, the child is being read stories which helps to develop their brain and teaches them new vocabulary. Most importantly, the game 20 helps to set the child up to eat healthy for the rest of their lives since the game 20 is placing the healthy food items 22 right in front of them, and teaching them to enjoy them in a positive fashion, rather than hiding them, masking them or using potentially negative or otherwise discouraging tactics.

### Examples

As mentioned above, the content of the printed story 26 is designed to engage the child and encourage them to eat (or at least sample) the healthy food items 22—both through the compelling storylines themselves and through the offering of incentive food items as a reward. The variety of content that the printed story 26 may incorporate in any given embodiment is literally infinite. So long as the printed story 26 contains one or more of the healthy food-related components discussed above, the remaining content may include any subject matter or follow any format now known or later conceived. However, for illustrative purposes, some examples of possible content are provided below.

In at least one embodiment, the printed story 26 engages the child the help a protagonist character overcome or conquer a series of obstacles by way of eating the healthy food items 22, with a final “reward”—i.e., the incentive food item 24—to be presented to or shared with the child upon successfully completing the obstacles. Thus, the printed story 26 describes the series of obstacles, while the placemat artwork 44 illustrates the obstacles (also, the positions of the healthy food locations 46), with each of the healthy food items 22 being positioned on the obstacles by virtue of the healthy food locations 46. The printed story 26 also provides the associated life lesson section 54, based on the content of the story, and at least one talking point 56 that allow the parent or guardian to engage in meaningful discussions with the child about important, teachable moments, beyond just nutrition and the healthy food items 22. Again, this is just one type of printed story 26 that could be utilized in the game 20.

By way of more specific examples, building on the above-described printed story 26 structure, one such printed story 26 (as illustrated in the placemat artwork of FIG. 1) follows a protagonist who is competing in a stunt competition. The antagonist is a rival competitor who has placed various obstacles (i.e., health food items 22) in the protagonist's path. Thus, the child is tasked with the job of removing each of the obstacles by eating the appropriate health food items 22 as the story progresses, so that the protagonist may complete the stunt course and win the prize (i.e., the incentive food item 24) that the protagonist then shares with the child. In such a story, the life lesson section 54 and associated talking points 56 may deal with the issue of cheating.

By way of a further example, another such printed story 26 follows a protagonist who is in a car race against the antagonist. However, there are various obstacles (i.e., health food items 22) that have fallen onto the roadway. Thus, the child is tasked with the job of removing each of the obstacles by eating the appropriate health food items 22 as the story progresses, so that the protagonist may finish the race first and win the prize (i.e., the incentive food item 24) that the protagonist then shares with the child. In such a story, the life lesson section 54 and associated talking points 56 may deal with the issue of sharing.

By way of a still further example, another such printed story 26 follows a protagonist who must travel around a map via a ship in order to collect all of his healthy food items 22 that have been stashed away before the antagonists are able to find and steal them. Thus, the child is tasked with the job of hiding the healthy food items 22 in their stomach as the story progresses to prevent them from being stolen. At the end of the story, the protagonist learns that the antagonists weren't trying to steal the food, but were simply hungry; so the protagonist decides to give some of the prize treat (i.e., the incentive food item 24) to them. In such a story, the life lesson section 54 and associated talking points 56 may deal with the issues of giving and charity.

By way of a still further example, another such printed story 26 follows a protagonist crab who requires assistance cleaning up a bunch of healthy food items 22 that have accidentally spilled into the ocean, all over its reef. Thus, the child is tasked with the job of cleaning up the reef by eating the healthy food items 22 as the story progresses. Upon completing the job, the child is rewarded with the incentive food item 24. In such a story, the life lesson section 54 and associated talking points 56 may deal with the issue of environmental conservation.

By way of a still further example, another such printed story 26 follows a protagonist who lives on a planet that has very boring food, so the protagonist volunteers to explore other planets in search of new healthy food items 22 with the assistance of the child. Thus, the child is tasked with eating all of the new healthy food items 22 that are discovered as the story progresses, so as to store them in their stomach to bring back to the home planet. Upon returning to the home planet, the child is rewarded with the incentive food item 24 for their bravery in discovering and trying new healthy food items 22. In such a story, the life lesson section 54 and associated talking points 56 may deal with bravery and overcoming fears.

By way of a still further example, another such printed story 26 follows a protagonist who receives a scavenger hunt challenge from a disrespectful antagonist. Thus, the child is tasked with storing the items found by the protagonist (i.e., healthy food items 22) in their stomach during the scavenger hunt so that the protagonist may win. Upon winning the scavenger hunt, the protagonist receives an apology from the antagonist, at which point the protagonist decides to forgive and share the prize (i.e., the incentive food item 24) with the antagonist and the child. In such a story, the life lesson section 54 and associated talking points 56 may deal with humility and forgiveness.

By way of a still further example, another such printed story 26 follows a protagonist farmer who requires assistance in rounding up his animals that have been stolen by the antagonist. Thus, the child is tasked with eating each animal's favorite snacks (i.e., the healthy food items 22) so that the animals will follow the farmer and the child back to the farm, at which point the child is rewarded with the incentive food item 24 for helping. In such a story, the life lesson section 54 and associated talking points 56 may deal with stealing.

Aspects of the present specification may also be described as follows:

1. A method of playing an interactive nutrition game for encouraging an at least one child to eat healthy foods, the game comprising a printed story involving healthy foods and a placemat containing artwork related to the content of the printed story, the method comprising the steps of: selecting an at least one healthy food item for the at least one child to eat; selectively placing each of the at least one healthy food item on a corresponding at least one designated healthy food location provided by the placemat artwork; selectively populating an at least one healthy food placeholder positioned within the printed story with a food name of the at least one healthy food item selected for the at least one child to eat, each such healthy food item having at least one such corresponding healthy food placeholder within the printed story; reciting the printed story to the child; upon encountering each of the at least one healthy food placeholder while reciting the printed story to the child, encouraging the child to eat the associated healthy food item positioned on the placemat.

2. The method according to embodiment 1, wherein the step of selectively placing each of the at least one healthy food item on a corresponding at least one designated healthy food location further comprises the step of selectively ordering the placement of the at least one healthy food item based on the child's familiarity with each of the at least one healthy food item.

3. The method according to embodiments 1-2, wherein the step of selecting the at least one healthy food item for the at least one child to eat further comprises the steps of: selecting a first healthy food item for the at least one child to eat; selecting a second healthy food item for the at least one child to eat; selecting a third healthy food item for the at least one child to eat; and selecting a fourth healthy food item for the at least one child to eat.

4. The method according to embodiments 1-3, wherein the step of selectively placing each of the at least one healthy food item on the corresponding at least one designated healthy food location provided by the placemat artwork further comprises the steps of: selectively placing the first healthy food item on a corresponding first healthy food location; selectively placing the second healthy food item on a corresponding second healthy food location; selectively placing the third healthy food item on a corresponding third healthy food location; and selectively placing the fourth healthy food item on a corresponding fourth healthy food location.

5. The method according to embodiments 1-4, wherein the step of selectively populating the at least one healthy food placeholder further comprises the steps of: selectively populating a first healthy food placeholder with the food name of the first healthy food item; selectively populating a second healthy food placeholder with the food name of the second healthy food item; selectively populating a third healthy food placeholder with the food name of the third healthy food item; and selectively populating a fourth healthy food placeholder with the food name of the fourth healthy food item.

6. The method according to embodiments 1-5, further comprising the step of selectively populating an at least one child placeholder positioned within the printed story with a child name of the at least one child.

7. The method according to embodiments 1-6, further comprising the step of, upon the child eating the at least one healthy food item positioned on the placemat, providing the child with positive reinforcement.

8. The method according to embodiments 1-7, further comprising the step of, upon the child refusing to eat the at least one healthy food item positioned on the placemat, encouraging the child to at least sample said at least one healthy food item.

9. The method according to embodiments 1-8, further comprising the steps of: selecting an at least one incentive food item for the at least one child to eat; selectively placing each of the at least one incentive food item on a corresponding at least one designated incentive food location provided by the placemat artwork; selectively populating an at least one incentive food placeholder positioned within the printed story with a food name of the at least one incentive food item selected for the at least one child to eat, each such incentive food item having at least one such corresponding incentive food placeholder within the printed story; and upon the child eating the at least one healthy food item positioned on the placemat, allowing the child to eat the at least one incentive food item positioned on the placemat as a reward.

10. The method according to embodiments 1-9, further comprising the step of discussing the content of the printed story with the child while the child eats the at least one incentive food item.

11. A method of playing an interactive nutrition game for encouraging an at least one child to eat healthy foods, the game comprising a printed story involving healthy foods and a placemat containing artwork related to the content of the printed story, the method comprising the steps of: selecting an at least one healthy food item for the at least one child to eat; selecting an at least one incentive food item for the at least one child to eat; selectively placing each of the at least one healthy food item on a corresponding at least one designated healthy food location provided by the placemat artwork, said at least one healthy food location positioned on the placemat artwork in accordance with the content of the printed story; selectively placing each of the at least one incentive food item on a corresponding at least one designated incentive food location provided by the placemat artwork, said at least one incentive food location positioned on the placemat artwork in accordance with the content of the printed story; selectively populating an at least one healthy food placeholder positioned within the printed story with a food name of the at least one healthy food item selected for the at least one child to eat, each such healthy food item having at least one such corresponding healthy food placeholder within the printed story; selectively populating an at least one incentive food placeholder positioned within the printed story with a food name of the at least one incentive food item selected for the at least one child to eat, each such incentive food item having at least one such corresponding incentive food placeholder within the printed story; reciting the printed story to the child, including the appropriate food names associated with the at least one healthy food placeholder and incentive food placeholder; upon encountering each of the at least one healthy food placeholder while reciting the printed story to the child, encouraging the child to eat the associated healthy food item positioned on the placemat; and upon the child eating the at least one healthy food item positioned on the placemat, allowing the child to eat the at least one incentive food item positioned on the placemat as a reward.

12. An interactive nutrition game for encouraging an at least one child to eat healthy foods, the game comprising: an at least one healthy food item for the at least one child to eat; an at least one incentive food item for the at least one child to eat; a printed story involving healthy foods, the printed story providing: an at least one healthy food placeholder positioned within the printed story and configured for being selectively populated with a food name of the at least one healthy food item, each such healthy food item having at least one such corresponding healthy food placeholder within the printed story; and an at least one incentive food placeholder positioned within the printed story and configured for being selectively populated with a food name of the at least one incentive food item, each such incentive food item having at least one such corresponding incentive food placeholder within the printed story; and a placemat containing artwork related to the content of the printed story, the placemat artwork providing: an at least one designated healthy food location positioned on the placemat artwork in accordance with the content of the printed story, each of the at least one designated healthy food location configured for receiving one of the at least one healthy food item; and an at least one designated incentive food location positioned on the placemat artwork in accordance with the content of the printed story, each of the at least one designated incentive food location configured for receiving one of the at least one incentive food item; whereby, upon encountering each of the at least one healthy food placeholder while reciting the printed story to the child, the child is encouraged to eat the associated healthy food item positioned on the placemat, and upon eating the at least one healthy food item positioned on the placemat, the child is allowed to eat the at least one incentive food item positioned on the placemat as a reward.

13. The interactive nutrition game according to embodiment 12, further comprising: a first healthy food item for the at least one child to eat, the first healthy food item positionable on a corresponding first healthy food location provided by the placemat artwork; a second healthy food item for the at least one child to eat, the second healthy food item positionable on a corresponding second healthy food location provided by the placemat artwork; a third healthy food item for the at least one child to eat, the third healthy food item positionable on a corresponding third healthy food location provided by the placemat artwork; and a fourth healthy food item for the at least one child to eat, the fourth healthy food item positionable on a corresponding fourth healthy food location provided by the placemat artwork.

14. The interactive nutrition game according to embodiments 12-13, wherein the printed story further provides: a first healthy food placeholder configured for being selectively populated with the food name of the first healthy food item; a second healthy food placeholder configured for being selectively populated with the food name of the second healthy food item; a third healthy food placeholder configured for being selectively populated with the food name of the third healthy food item; and a fourth healthy food placeholder configured for being selectively populated with the food name of the fourth healthy food item.

15. The interactive nutrition game according to embodiments 12-14, wherein the printed story further provides an at least one child placeholder positioned within the printed story and configured for being selectively populated with a child name of the at least one child.

16. The interactive nutrition game according to embodiments 12-15, wherein the printed story further provides: an at least one eating suggestion for how to praise the child upon eating the at least one healthy food item; and an at least one refusal suggestion for how to encourage the child upon refusing to eat the at least one healthy food item.

17. The interactive nutrition game according to embodiments 12-16, wherein the printed story further provides an at least one life lesson section containing an at least one talking point for discussion with the child while the child eats the at least one incentive food item.

In closing, regarding the exemplary embodiments of the present invention as shown and described herein, it will be appreciated that an interactive nutrition game and associated methods of use are disclosed and configured for encouraging children to eat healthy foods. Because the principles of the invention may be practiced in a number of configurations beyond those shown and described, it is to be understood that the invention is not in any way limited by the exemplary embodiments, but is generally directed to an interactive nutrition game configured for encouraging children to eat healthy foods, and is able to take numerous forms to do so without departing from the spirit and scope of the invention. It will also be appreciated by those skilled in the art that the present invention is not limited to the particular geometries and materials of construction disclosed, but may instead entail other functionally comparable structures or materials, now known or later developed, without departing from the spirit and scope of the invention. Furthermore, the various features of each of the above-described embodiments may be combined in any logical manner and are intended to be included within the scope of the present invention.

Groupings of alternative embodiments, elements, or steps of the present invention are not to be construed as limitations. Each group member may be referred to and claimed individually or in any combination with other group members disclosed herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Unless otherwise indicated, all numbers expressing a characteristic, item, quantity, parameter, property, term, and so forth used in the present specification and claims are to be understood as being modified in all instances by the term “about.” As used herein, the term “about” means that the characteristic, item, quantity, parameter, property, or term so qualified encompasses a range of plus or minus ten percent above and below the value of the stated characteristic, item, quantity, parameter, property, or term. Accordingly, unless indicated to the contrary, the numerical parameters set forth in the specification and attached claims are approximations that may vary. At the very least, and not as an attempt to limit the application of the doctrine of equivalents to the scope of the claims, each numerical indication should at least be construed in light of the number of reported significant digits and by applying ordinary rounding techniques. Notwithstanding that the numerical ranges and values setting forth the broad scope of the invention are approximations, the numerical ranges and values set forth in the specific examples are reported as precisely as possible. Any numerical range or value, however, inherently contains certain errors necessarily resulting from the standard deviation found in their respective testing measurements. Recitation of numerical ranges of values herein is merely intended to serve as a shorthand method of referring individually to each separate numerical value falling within the range. Unless otherwise indicated herein, each individual value of a numerical range is incorporated into the present specification as if it were individually recited herein.

The terms “a,” “an,” “the” and similar referents used in the context of describing the present invention (especially in the context of the following claims) are to be construed to cover both the singular and the plural, unless otherwise indicated herein or clearly contradicted by context. All methods described herein can be performed in any suitable order unless otherwise indicated herein or otherwise clearly contradicted by context. The use of any and all examples, or exemplary language (e.g., “such as”) provided herein is intended merely to better illuminate the present invention and does not pose a limitation on the scope of the invention otherwise claimed. No language in the present specification should be construed as indicating any non-claimed element essential to the practice of the invention.

Specific embodiments disclosed herein may be further limited in the claims using consisting of or consisting essentially of language. When used in the claims, whether as filed or added per amendment, the transition term “consisting of” excludes any element, step, or ingredient not specified in the claims. The transition term “consisting essentially of” limits the scope of a claim to the specified materials or steps and those that do not materially affect the basic and novel characteristic(s). Embodiments of the present invention so claimed are inherently or expressly described and enabled herein.

It should be understood that the processes, methods, and the order in which the respective elements of each method are performed are purely exemplary. Depending on the implementation, they may be performed in any order or in parallel, unless indicated otherwise in the present disclosure.

While aspects of the invention have been described with reference to at least one exemplary embodiment, it is to be clearly understood by those skilled in the art that the invention is not limited thereto. Rather, the scope of the invention is to be interpreted only in conjunction with the appended claims and it is made clear, here, that the inventor(s) believe that the claimed subject matter is the invention.

What is claimed is:

1. A method of playing an interactive nutrition game for encouraging an at least one child to eat healthy foods, the game comprising a printed story involving healthy foods and a placemat containing artwork related to the content of the printed story, the method comprising the steps of:
selecting an at least one healthy food item for the at least one child to eat;
selectively placing each of the at least one healthy food item on a corresponding at least one designated healthy food location provided by the placemat artwork;
selectively populating an at least one healthy food placeholder positioned within the printed story with a food name of the at least one healthy food item selected for the at least one child to eat, each such healthy food item having at least one such corresponding healthy food placeholder within the printed story;
reciting the printed story to the child; and
upon encountering each of the at least one healthy food placeholder while reciting the printed story to the child, encouraging the child to eat the associated healthy food item positioned on the placemat.

2. The method of claim 1, wherein the step of selectively placing each of the at least one healthy food item on a corresponding at least one designated healthy food location further comprises the step of selectively ordering the placement of the at least one healthy food item based on the child's familiarity with each of the at least one healthy food item.

3. The method of claim 1, wherein the step of selecting the at least one healthy food item for the at least one child to eat further comprises the steps of:
selecting a first healthy food item for the at least one child to eat;
selecting a second healthy food item for the at least one child to eat;
selecting a third healthy food item for the at least one child to eat; and
selecting a fourth healthy food item for the at least one child to eat.

4. The method of claim 3, wherein the step of selectively placing each of the at least one healthy food item on the corresponding at least one designated healthy food location provided by the placemat artwork further comprises the steps of:
selectively placing the first healthy food item on a corresponding first healthy food location;
selectively placing the second healthy food item on a corresponding second healthy food location;
selectively placing the third healthy food item on a corresponding third healthy food location; and
selectively placing the fourth healthy food item on a corresponding fourth healthy food location.

5. The method of claim 3, wherein the step of selectively populating the at least one healthy food placeholder further comprises the steps of:
selectively populating a first healthy food placeholder with the food name of the first healthy food item;
selectively populating a second healthy food placeholder with the food name of the second healthy food item;
selectively populating a third healthy food placeholder with the food name of the third healthy food item; and
selectively populating a fourth healthy food placeholder with the food name of the fourth healthy food item.

6. The method of claim 1, further comprising the step of selectively populating an at least one child placeholder positioned within the printed story with a child name of the at least one child.

7. The method of claim 1, further comprising the step of, upon the child eating the at least one healthy food item positioned on the placemat, providing the child with positive reinforcement.

8. The method of claim 1, further comprising the step of, upon the child refusing to eat the at least one healthy food item positioned on the placemat, encouraging the child to at least sample said at least one healthy food item.

9. The method of claim 1, further comprising the steps of:
selecting an at least one incentive food item for the at least one child to eat;
selectively placing each of the at least one incentive food item on a corresponding at least one designated incentive food location provided by the placemat artwork;
selectively populating an at least one incentive food placeholder positioned within the printed story with a food name of the at least one incentive food item selected for the at least one child to eat, each such incentive food item having at least one such corresponding incentive food placeholder within the printed story; and
upon the child eating the at least one healthy food item positioned on the placemat, allowing the child to eat the at least one incentive food item positioned on the placemat as a reward.

10. The method of claim 1, further comprising the step of discussing the content of the printed story with the child while the child eats the at least one incentive food item.

11. A method of playing an interactive nutrition game for encouraging an at least one child to eat healthy foods, the game comprising a printed story involving healthy foods and a placemat containing artwork related to the content of the printed story, the method comprising the steps of:
selecting an at least one healthy food item for the at least one child to eat;
selecting an at least one incentive food item for the at least one child to eat;
selectively placing each of the at least one healthy food item on a corresponding at least one designated healthy food location provided by the placemat artwork, said at least one healthy food location positioned on the placemat artwork in accordance with the content of the printed story;
selectively placing each of the at least one incentive food item on a corresponding at least one designated incentive food location provided by the placemat artwork, said at least one incentive food location positioned on the placemat artwork in accordance with the content of the printed story;
selectively populating an at least one healthy food placeholder positioned within the printed story with a food name of the at least one healthy food item selected for the at least one child to eat, each such healthy food item having at least one such corresponding healthy food placeholder within the printed story;
selectively populating an at least one incentive food placeholder positioned within the printed story with a food name of the at least one incentive food item selected for the at least one child to eat, each such incentive food item having at least one such corresponding incentive food placeholder within the printed story;
reciting the printed story to the child, including the appropriate food names associated with the at least one healthy food placeholder and incentive food placeholder;
upon encountering each of the at least one healthy food placeholder while reciting the printed story to the child, encouraging the child to eat the associated healthy food item positioned on the placemat; and
upon the child eating the at least one healthy food item positioned on the placemat, allowing the child to eat the at least one incentive food item positioned on the placemat as a reward.

12. An interactive nutrition game for encouraging an at least one child to eat healthy foods, the game comprising:
an at least one healthy food item for the at least one child to eat;
an at least one incentive food item for the at least one child to eat;
a printed story involving healthy foods, the printed story providing:
an at least one healthy food placeholder positioned within the printed story and configured for being selectively populated with a food name of the at least one healthy food item, each such healthy food item having at least one such corresponding healthy food placeholder within the printed story; and
an at least one incentive food placeholder positioned within the printed story and configured for being selectively populated with a food name of the at least one incentive food item, each such incentive food item having at least one such corresponding incentive food placeholder within the printed story; and
a placemat containing artwork related to the content of the printed story, the placemat artwork providing:
an at least one designated healthy food location positioned on the placemat artwork in accordance with the content of the printed story, each of the at least one designated healthy food location configured for receiving one of the at least one healthy food item; and
an at least one designated incentive food location positioned on the placemat artwork in accordance with the content of the printed story, each of the at least one designated incentive food location configured for receiving one of the at least one incentive food item;
whereby, upon encountering each of the at least one healthy food placeholder while reciting the printed story to the child, the child is encouraged to eat the associated healthy food item positioned on the placemat, and upon eating the at least one healthy food item positioned on the placemat, the child is allowed to eat the at least one incentive food item positioned on the placemat as a reward.

13. The interactive nutrition game of claim 12, further comprising:
a first healthy food item for the at least one child to eat, the first healthy food item positionable on a corresponding first healthy food location provided by the placemat artwork;
a second healthy food item for the at least one child to eat, the second healthy food item positionable on a corresponding second healthy food location provided by the placemat artwork;
a third healthy food item for the at least one child to eat, the third healthy food item positionable on a corresponding third healthy food location provided by the placemat artwork; and
a fourth healthy food item for the at least one child to eat, the fourth healthy food item positionable on a corresponding fourth healthy food location provided by the placemat artwork.

14. The interactive nutrition game of claim 13, wherein the printed story further provides:
a first healthy food placeholder configured for being selectively populated with the food name of the first healthy food item;
a second healthy food placeholder configured for being selectively populated with the food name of the second healthy food item;
a third healthy food placeholder configured for being selectively populated with the food name of the third healthy food item; and
a fourth healthy food placeholder configured for being selectively populated with the food name of the fourth healthy food item.

15. The interactive nutrition game of claim 12, wherein the printed story further provides an at least one child placeholder positioned within the printed story and configured for being selectively populated with a child name of the at least one child.

16. The interactive nutrition game of claim 12, wherein the printed story further provides:
an at least one eating suggestion for how to praise the child upon eating the at least one healthy food item; and
an at least one refusal suggestion for how to encourage the child upon refusing to eat the at least one healthy food item.

17. The interactive nutrition game of claim 12, wherein the printed story further provides an at least one life lesson section containing an at least one talking point for discussion with the child while the child eats the at least one incentive food item.
